(19) United States
(12) Patent Application Publication
(10) Pub. No.: US 2014/0003632 A1
(43) Pub. Date: Jan. 2, 2014

(54) MICROPHONE ARRANGEMENT

(71) Applicant: Erwin REINISCH, Kalsdorf (AT)

(72) Inventor: Erwin REINISCH, Kalsdorf (AT)

(73) Assignee: ams AG, Unterpremstaetten (AT)

(21) Appl. No.: 13/536,431

(22) Filed: Jun. 28, 2012

(51) Int. Cl. H04R 1/00

(52) U.S. Cl. 381/174

(57) ABSTRACT

A microphone arrangement including a stack, the stack further including a MEMS microphone and a MEMS interface. The MEMS microphone includes a semiconductor body having a movable member on a first main surface, and the MEMS interface includes another semiconductor body having contact pads on a second main surface. The MEMS microphone and the MEMS interface are electrically connected via the contact pads with the first main surface facing the second main surface.

### BACKGROUND

The present disclosure generally relates to a microphone arrangement.

Microphone arrangements find various applications in mobile radio and landline communication appliances. Other fields of application include hearing aids and Dictaphones, to name but a few. There is an ever growing demand for compact and low current design. One approach to meet these requirements lies in the implementation of micro-techniques, for example, using micro-electro-mechanical systems (MENS).

MEMS microphones are capacitive sensing devices. Basically they operate as high frequency pressure sensor. The microphone typically has a membrane or diaphragm which includes two capacitor plates that, under the influence of sound waves, vibrate with respect to each other. This results in change of the capacitance which can be measured as a microphone signal. In order to amplify the typically low intensity microphone signal MEMS microphones are equipped with an associated application specific integrated circuit (ASIC) to carry out data (pre-)processing before the microphone signal is supplied to target components like loudspeakers or sound recognition units. Typically such ASICs are also produced with micro-techniques and are named MEMS interfaces hereinafter.

Using micro-technology, microphone arrangements can be downsized into the micrometer regime. The overall size, however, is generally restricted by the physics of sound. Sound-waves require the microphone diaphragm is large enough to interact with induced pressure variations in the range of some 10 Pascal. In order to design even smaller setups, novel and economic assembly processes are needed.

### SUMMARY

According to one aspect of the present disclosure, a microphone arrangement includes a stack. The stack includes a MEMS microphone and a MEMS interface. The MEMS microphone includes a semiconductor body having a movable member on a first main surface, and the MEMS interface includes another semiconductor body having contact pads on a second main surface. The MEMS microphone and the MEMS interface are electrically connected via the contact pads with the first main surface facing the second main surface. In some aspects, the first main surface comprises a lateral area framing the movable member, and the contact pads are connected to the active area with a gap between the first and second surface.

According to another aspect of the present disclosure, a microphone arrangement is provided. The arrangement includes a MEMS microphone including a semiconductor body having a movable member on a first main surface, and a MEMS interface including another semiconductor body having contact pads on a second main surface. The MEMS microphone and the MEMS interface are electrically connected via the contact pads with the first main surface facing the second main surface. In some aspects, the first main surface comprises a lateral area framing the movable member, and the contact pads are connected to the active area with a gap between the first and second surface.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed examples and aspects of the subject technology, and together with the description serve to explain the principles of the disclosed subject technology. In the drawings:

FIG. 1 shows an example of a microphone arrangement according to the present principle.

FIG. 2 shows another example of a microphone arrangement according to the present principle.

FIG. 3 shows a top and lateral view of an example microphone arrangement according to the present principle.

FIG. 4 shows another example of a microphone arrangement according to the present principle.

### DETAILED DESCRIPTION

According to one aspect of the disclosure, a microphone arrangement includes a stack. The stack further includes a MEMS microphone and a MEMS interface. The MEMS microphone includes a semiconductor body having a movable member on a first main surface. The MEMS interface includes another semiconductor body having contact pads on a second main surface. Finally, the MEMS microphone and the MEMS interface are electrically connected via the contact pads with the first main surface facing the second main surface.

The movable member of the MEMS microphone is designed in such a way that it can interact with pressure variations induced by sound-waves incident on the microphone arrangement. The sound-induced movement in the movable member causes the generation of a microphone signal proportional to the sound pressure induced movement in the member. This characteristic microphone signal is supplied to the MEMS interface via the electrical connection established by the contact pads.

The MEMS interface includes elements to further process the typically low intensity microphone signal. For example, the MEMS interface includes an amplifier to amplify the microphone signal into an intensity sufficient for further processing steps. The signal processing performed by the MEMS interface can either be analog or digital. It is well within the scope of the present principle that the MEMS interface may include further processing elements and is not restricting the scope of the present principle. In particular, the MEMS interface may perform a complete signal processing or, alternatively, supplies a pre-processed microphone signal to further processing components connected to the microphone arrangement.

The proposed stack design of the microphone arrangement and its MEMS components result allow for a reduced die size of the complete microphone arrangement. This renders possible the implementation of the arrangement into systems in which size is critical, e.g. hearing devices. Because of the local vicinity of the MEMS interface and the MEMS microphone short electrical connections can be used between these components and to other neighboring components. This results in low noise performance. As the MEMS interface is connected or stacked via contact pads additional bond wires are not necessary. The area such as the second main surface can be better utilized as no additional space needs to be reserved for bond connections. The overall production cost of the microphone arrangement is reduced due to the smaller size of the structure. The resulting microphone arrangement can be easily connected to smaller PCB boards and packaged using rather cheap CSP processing. Finally, because CSP assembly methods can be used, the microphone arrangement can be assembled more quickly, e.g. by soldering contact pads on the surfaces which is faster than using bonding wires.

In one aspect, the first main surface includes a lateral area framing the movable member. The movable member is etched into the semiconductor body such that the lateral are surrounds it. The contact pads are connected to the lateral area with a gap between the first and second surfaces. The lateral area is used to establish the connections to the MEMS interface via the contact pads and to other neighbouring components, for example by bond wires. The movable member itself is electrically connected to the MEMS interface or neighbouring components via circuitry included in the lateral area. The movable member needs to freely vibrate under the influence of sound-waves. This is guaranteed by a sufficient gap between first and second main surfaces.

In one aspect, the lateral area includes an integrated circuit. The integrated circuit includes electrical connections to the MEMS interface via the contact pads. The integrated circuit may additionally include connections to other neighbouring components in order to supply the microphone signal for further processing by these components. Generally, the integrated circuit may include other electrical integrated components such as filters, amplifiers and the like. While this is possible, the general approach of this disclosure is to place most processing components into the MEMS interface.

In one aspect, the MEMS interface is mounted to the MEMS microphone such that the semiconductor body having the contact pads is arranged on top of the movable member. In this configuration the contact pads are connected to the lateral area and there is a gap between the MEMS interface and the movable member. There is some degree of freedom as to where exactly put the MEMS interface with respect to the MEMS microphone. In this configuration, however, the MEMS interface covers the movable member at least in part.

In one aspect, the MEMS interface is mounted to the MEMS microphone such that the semiconductor body having the contact pads is arranged off-centre with respect to the movable member. In other words. the MEMS interface is placed on the lateral area or edges of the semiconductor body including the movable member.

In one aspect, the MEMS microphone is mounted onto a printed circuit board via a third main surface of the semiconductor body having the movable member. The printed circuit board serves as a mount for the microphone arrangement but may include further electronic components. Further components, such as processing units, that use the microphone signal received by the microphone arrangement, can be mounted on the same printed circuit board, effectively building up a larger electronic system.

In one aspect, the semiconductor body of the MEMS microphone is electrically connected to the printed circuit board. Generally, the connection can be established via bonding wires or other techniques like through-silicon via (TSV).

In one aspect, the MEMS microphone and/or the MEMS interface is electrically connected to the printed circuit board via a bond connection.

The bond connection in the stack included by the microphone arrangement can be rather short and thereby has a low noise output.

In one aspect, the printed circuit board includes a sound hole facing the movable member. In order for sound-waves to interact with the movable member and generate a microphone signal, the sound waves need to enter the microphone arrangement. When mounted onto the printed circuit board this can be achieved by cutting a sound hole of appropriate width into the printed circuit board itself. The semiconductor body of the MEMS microphone preferably has a cavity to facilitate wave propagation onto the movable member. This cavity may also have certain focussing or resonance capabilities.

In one aspect, the MEMS microphone and the MEMS interface are packaged by a cover member. In order to seal the microphone arrangement and avoid environmental influence, the microphone arrangement is packaged into a MEMS package using the cover member. This can be achieved by standard packaging technology.

In one aspect, the cover member includes a sound hole facing the movable member. In a similar manner as described above, sound waves need to enter the microphone arrangement via the sound hole. In this aspect, alternatively or in addition to the sound hole described above, the sound hole is designed into the cover member.

In one aspect, the second surface of the MEMS interface includes an integrated circuit. The integrated circuit of the MEMS interface includes components for (pre-) processing the microphone signal. These components can either be analog or digital. For example, the integrated circuit may include an amplifier arrangement to adjust the signal amplitude with an amplification gain.

In one aspect, the MEMS microphone and the MEMS interface are connected to each other by glue or by solder balls. The contact pads have different functionally. They establish an electrical connection between the MEMS interface and the MEMS microphone. Additionally, they also establish a mechanical connection between these structures. In order to achieve a permanent or rigid connection, glue or solder material can be used to establish the mechanical connection.

In one aspect, the movable member includes a diaphragm. The microphone diaphragm needs to be large enough to interact with pressure variations induced by the sound-waves entering the microphone arrangement. The diaphragm can be covered with an array of small holes which allow air to easier escape from the cavity which may be designed between the diaphragm and the semiconductor body.

According to one aspect, the movable member includes a capacitor, in particular a piezoelectric element. The capacitor in the movable member has a first and second plate which defines the capacity of the capacitor. Preferably, one of these two plates is covered with the array of small holes to allow air to escape from the cavity between the two plates of the capacitor during operation. That means that the two membranes or capacitor plates are separated by an air gap.

Under the influence of the sound wave, the two capacitor plates vibrate with respect to each other. This results in a variation of capacitance that is generating the microphone signal. This microphone signal may be further amplified using the MEMS interface as described above.

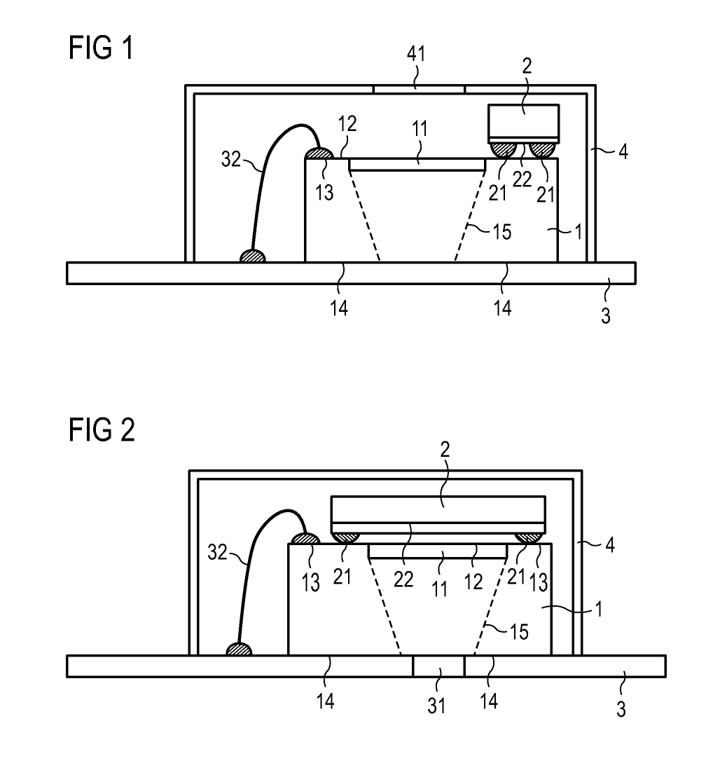

FIG. 1 shows an example of a microphone arrangement according to the present principle. The microphone arrangement includes a stack of a MEMS microphone 1 and a MEMS interface 2. The MEMS microphone 1 includes a semiconductor body which further includes a movable member 11. The movable member 11 and a lateral area 13 define a first main surface of the semiconductor body. The MEMS interface 2 includes another semiconductor body which has a second main surface 22. Contact pads 21 are attached to the second main surface.

The MEMS microphone 1 and the MENS interface 2 are stacked onto each other such that the first and second main surfaces face each other. The contact pads 21 establish an electrical connection between the MEMS microphone 1 and the MEMS interface 2. The contact pads have a typical height of 90 m to 170 m. In this way a gap remains between the second and first main surface.

The MEMS microphone 1 constitutes a sound sensitive sensor. Movable member 11 includes a capacitor with a bottom and top plate or a piezoelectric element. The capacitor is connected with the semiconductor body of the MEMS microphone such that one of its plates (top plate hereinafter) forms part of the first main surface. The second capacitor plate (bottom plate hereinafter) has a certain distance with respect to the top plate. Below the bottom plate a cavity 15 can be etched into the semiconductor material. The cavity 15 is designed to guide and/or focus sound waves onto the movable member 11. In order to facilitate sensitivity of the top plate or bottom plate to sound-waves, either one or both of the plates can be covered with small holes so air can move easier between them.

Lateral area 13 includes an integrated circuit which includes electrical connections from the movable member 11 to the MEMS interface 2 via contact pads 21 as well as electrical connections to a bond wire 32. The semiconductor body of the MEMS microphone 1 includes a third main surface to electrically connect or mount the semiconductor body to a printed circuit board 3.

The MEMS interface 2 has an active area 22 which includes an integrated circuit. The integrated circuit further includes data processing elements, such as amplifiers, filters, analog-to-digital converters or the like (not shown). The integrated circuit can either be of analog or digital design and includes all necessary processing elements.

The bond wire connection 32 connects the microphone arrangement of stacked MEMS microphone 1 and MEMS interface 2 to the printed circuit board 3. The microphone arrangement is packaged using a cover structure 4. In order to allow sound-waves to enter the microphone arrangement a sound hole 41 is cut into the cover structure 4.

FIG. 2 shows another example of a microphone arrangement according to the present principle. The microphone arrangement shown here is similar to that of FIG. 1. One difference is that the MEMS interface 2 is mounted on top of the movable member 11 and covers the member completely (or at least partly). In FIG. 1 the MEMS interface 2 is placed off-center with respect to the movable member 11.

As the MEMS interface 2 now covers all or parts of the movable member 11, the sound hole 41 is not designed into the cover structure 4 as entering sounds waves would be blocked by the interface 2. In this aspect, a sound hole 32 is cut into the printed circuit board 3 in order to allow sound-waves to enter the microphone arrangement. Preferably, cavity 15 is designed to guide and/or focus the entering sound-waves onto the bottom plate of the movable member 11. Small holes can cover the capacitor plates of movable member 11 and may alternatively be placed on the bottom plate ad/or top plate.

The general working principle of the microphone arrangements according to FIGS. 1 and 2 are similar. The sound waves to be detected, i.e. generating the microphone signal, enter the microphone arrangement either through sound hole 31 or 41 and hit the movable member 11 either on its top or bottom plate. In either case the bottom or top plate of the movable member 11, in particular, is sensitive to the pressure imparted on the movable member 11 by the entered sound waves.

MEMS microphones in general are capacitive sensing devices. Basically, they operate like high-frequency pressure sensors. The movable member 11 or diaphragm, which is included of the bottom and top capacitor plates, vibrate with respect to each other under the influence of the sound wave. This results in variation of the capacitance and generates the microphone signal. Via the electrical connections between the MEMS microphone 1 and the MEMS interface 2 established by the contact pads 21, the microphone signal is supplied to the MEMS interface 2.

The MEMS interface 2 at least includes components to (pre-)process the microphone signal to produce an analog or digital output signal. In other aspects, not discussed here, the microphone MEMS interface 2 includes analog-to-digital converters and digital signal processing units within the interface's integrated circuit. The resulting analog or digital output signal can be provided to other components connected with the microphone arrangement via the bond wire 32 and via the printed circuit board 3.

The suggested stacked dye assembly has a couple of advantages. Due to the assembly method, the microphone size can be downscaled to about 1.5×2 mm. The actual microphone size is only limited by the requirements of the movable member 11 which, in turn, is restricted by the wavelength of sound-waves. The stacked microphone arrangement can be assembled by a rather cheap CSP (chip scale packaging) process. The size of the printed circuit board can also be reduced as microphone and interface are not placed side-by-side. This size reduction renders the whole production cheaper compared with prior art solutions. Furthermore, due to short electrical connections (contact pads 21 and bond wire 32) noise of the microphone arrangement can be kept rather low. In particular, the connection between the MEMS diaphragm 11 and the MEMS interface chip can be kept rather short in this arrangement. As no bond wire connections between the MEMS microphone and the MEMS interface are necessary, a larger interface area can be used for active components in the integrated circuits.

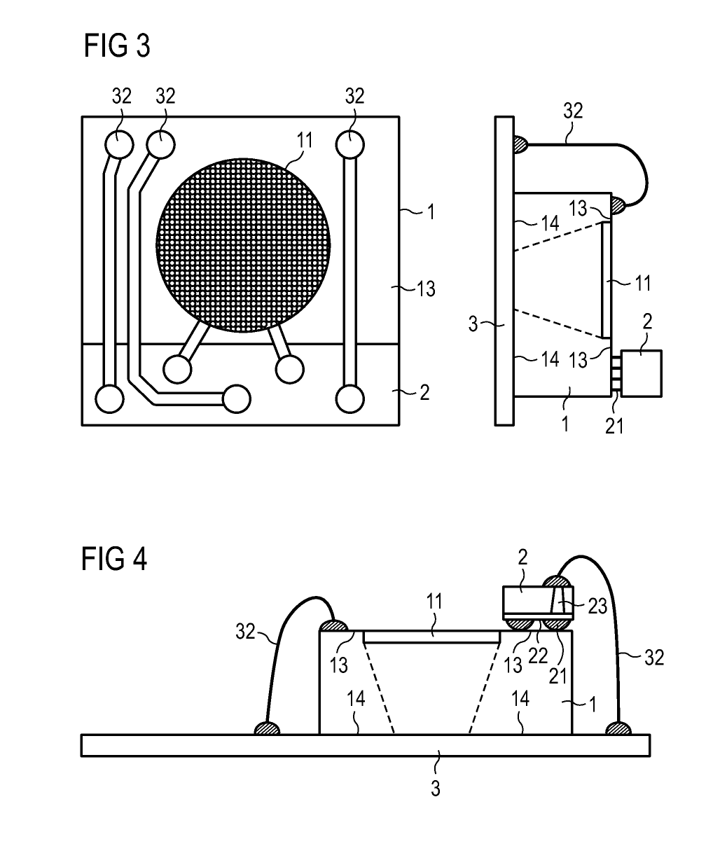

The left side of FIG. 3 shows a top view of a microphone arrangement according to the present principle. The MEMS interface 2 is connected on top of MEMS microphone 1 but attached via the contact pads 21 to lateral area 13. The stack of microphone 1 and MEMS interface 2 is mounted on top of the printed circuit board 3. The movable member 11 is of circular design and the small holes covering the top plate are easily visible in this drawing. Bond wires 32 establish electrical connection between the microphone arrangement, i.e. via the semiconductor body of MEMS microphone 1, and the printed circuit board 3. FIG. 3 also shows the circuit paths of the integrated circuits of the MEMS microphone 1 which includes the connections to MEMS interface 2. Connections include pins for ground, supply voltage as well as top and bottom plates of the movable member 11. For easier reference, the same microphone arrangement as seen in a side view is also sketched into FIG. 3, on the right side.

FIG. 4 shows another example of a microphone arrangement according to the present principle. This example can be based on either the microphone arrangement according to FIG. 2 or 3. The example shown here relates to the one of FIG. 1 (cover structure 4 and sound hole 31, 41 are not shown) .

The apparent difference lies in a connection between the MEMS interface 2 and the printed circuit board 3. This electrical connection is realized as another bond wire 32. Furthermore, the second main surface 22 (or e.g. the active surface including the integrated circuit) is electrically connected to the bond wire 32 via through-silicon via (TSV) connection. Other types of connection are possible as well if demanded by a given application.

In the foregoing, a phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While this specification contains many specifics, these should not be construed as limitations on the scope of what may be claimed, but rather as descriptions of particular implementations of the subject matter. Certain features that are described in this specification in the context of separate aspects and examples can also be implemented in combination in a single aspect or example. Conversely, various features that are described in the context of a single aspect or example can also be implemented in multiple aspects and example separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

These and other implementations are within the scope of the following claims.

1. A microphone arrangement, comprising a stack, the stack comprising a MEMS microphone and a MEMS interface, wherein
the MEMS microphone comprises a semiconductor body having a movable member on a first main surface,
the MEMS interface comprises another semiconductor body having contact pads on a second main surface,
the MEMS microphone and the MEMS interface are electrically connected via the contact pads with the first main surface facing the second main surface, and
the MEMS interface is an element produced with micro-techniques.

2. The microphone arrangement of claim 1, wherein
the first main surface comprises a lateral area framing the movable member, and
the contact pads are connected to the active area with a gap between the first and second surface.

3. The microphone arrangement of claim 1, wherein the lateral area comprises an integrated circuit.

4. The microphone arrangement of claim 1, wherein the MEMS interface is mounted to the MEMS microphone such that the semiconductor body having the contact pads is arranged on-top the movable member.

5. The microphone arrangement of claim 1, wherein the MEMS interface is mounted to the MEMS microphone such that the semiconductor body having the contact pads is arranged off-centre with respect to the movable member.

6. The microphone arrangement of claim 1, wherein the MEMS microphone is mounted onto a printed circuit board via a third main surface of the semiconductor body having the movable member.

7. The microphone arrangement of claim 6, wherein the semiconductor body of the MEMS microphone is electrically connected to the printed circuit board.

8. The microphone arrangement of claim 7, wherein the semiconductor body of the MEMS microphone and/or semiconductor body of the MEMS interface is electrically connected to the printed circuit board via a bond connection.

9. The microphone arrangement of claim 6, wherein the printed circuit board comprises a sound hole facing the movable member.

10. The microphone arrangement of claim 1, wherein the MEMS microphone and the MEMS interface are packaged by a cover member.

11. The microphone arrangement of claim 10, wherein the cover member comprises a sound hole facing the movable member.

12. The microphone arrangement of claim 1, wherein the second surface of the MEMS interface comprises an integrated circuit.

13. The microphone arrangement of claim 1, wherein for connecting the MEMS microphone and the MEMS interface the contact pads comprise a glue or a solder ball.

14. The microphone arrangement of claim 1, wherein the movable member comprises a diaphragm.

15. The microphone arrangement of claim 1, wherein the movable member comprises a capacitor, in particular a piezoelectric element.

16. A microphone arrangement, comprising:
a MEMS microphone including a semiconductor body having a movable member on a first main surface; and
a MEMS interface including another semiconductor body having contact pads on a second main surface;
wherein the MEMS microphone and the MEMS interface are electrically connected via the contact pads with the first main surface facing the second main surface, and wherein the MEMS interface is an element produced with micro-techniques.

17. The microphone arrangement of claim 16, wherein
the first main surface comprises a lateral area framing the movable member, and
the contact pads are connected to the active area with a gap between the first and second surface.

18. The microphone arrangement of claim 16, wherein the lateral area comprises an integrated circuit.

19. The microphone arrangement of claim 16, wherein the MEMS interface is mounted to the MEMS microphone such that the semiconductor body having the contact pads is arranged on-top the movable member.

20. The microphone arrangement of claim 16, wherein the MEMS interface is mounted to the MEMS microphone such that the semiconductor body having the contact pads is arranged off-centre with respect to the movable member.

21. A microphone arrangement, comprising:
a MEMS microphone including a semiconductor body having a movable member on a first main surface; and
a MEMS interface including another semiconductor body having contact pads on a second main surface;
wherein the MEMS microphone and the MEMS interface are electrically connected via the contact pads with the first main surface facing the second main surface,
wherein the MEMS interface is an element produced with micro-techniques,
wherein the MEMS microphone is mounted onto a printed circuit board, and
wherein the second main surface is electrically connected to the printed circuit board via at least one through-silicon via.
